(19) United States
(12) Patent Application Publication
(10) Pub. No.: US 2007/0011099 A1
(43) Pub. Date: Jan. 11, 2007

(54) SECURE ELECTRONIC TRANSACTIONS BETWEEN A MOBILE DEVICE AND OTHER MOBILE, FIXED, or VIRTUAL DEVICES

(76) Inventor: Conrad Sheehan, Kenilworth, IL (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/456,330

(22) Filed: Jul. 10, 2006

Related U.S. Application Data
(60) Provisional application No. 60/698,021, filed on Jul. 11, 2005.
(60) Provisional application No. 60/777,928, filed on Feb. 28, 2006.

(51) Int. Cl. G06Q 99/00

(52) U.S. Cl. 705/65

(57) ABSTRACT

In a system according to one embodiment of the present invention, the system includes a database for storing a merchant profile containing information associated with a merchant bank account. The system includes an application server that when a request from a merchant device for payment by the user for a transaction is received, the application generates an authorization message and sends it to a mobile device associated to the user. The application server will further wait to receive an acknowledgement message from the mobile device and will generate a validation message and send the message to the merchant device when an acknowledgement message is received. The application server further effectuates the transfer of funds from a user financial account to a merchant bank account.

### CROSS REFERENCE TO RELATED APPLICATIONS

The present invention claims priority to U.S. Provisional Application 60/698,021 filed Jul. 11, 2005 and claims priority to U.S. Provisional Application 60/777,928 filed Feb. 28, 2006, both of which are incorporated herein by reference.

### FIELD OF THE INVENTION

The present invention relates to a method and system for enabling and executing secure electronic transactions between a mobile device and other mobile, fixed, non-fixed or virtual devices, which pass through a centralized, secure payment clearance system. Preferably, the invention relates to methods and systems for enabling low cost, secure electronic payments between and among consumers and merchants using existing mobile communications, networks, internet, and telephone communications.

### BACKGROUND OF THE INVENTION

Typical existing payment systems which the consumers/merchants use today consist of a range of options from barter, cash, paper check, electronic bank account transfers, and plastic cards; each of which function in various ways to execute and finalize the transfer. Improvements upon these existing payment systems have resulted in various U.S. patents.

In U.S. Pat. Nos. 6,418,326; 6,078,806; and 5,887,266 there is described a mobile payment system in which payments are finalized through the creation of digital cash and the debiting and crediting of digital cash balances in an electronic purse. In these patents, while an alternate currency or value system is created, the systems still rely on and employ existing, ubiquitous systems of financial value and settlement. Furthermore, these systems in most circumstances require unique applications or processing requirements be present or added to the mobile device.

Other prior art in the area of electronic payments, namely U.S. Patent Application 20050102230, suggest the use of messaging communications to conduct portions of the financial transactions. This system requires the mobile telephony system to include a programmable message composition facility enabling details of a desired transaction to be input in structured fashion into a mobile telephone handset to compose a standardized transaction instruction-containing message formatted on the mobile telephone handset in order to be recognized by a payment center. Again these types of systems rely on the mobile handset to create and generate payment instructions.

There is, therefore, a need for improvements over the prior art by improving convenience, speed, security, effectiveness, and cost of the transaction. The present invention preferably through various embodiments uses a payment clearance system running one or more software applications to generate payment instructions sent to a mobile device associated to the consumer, who must then authorize the transaction and send the authorization back to the payment clearance system. At no point does the mobile device compose or format initial instructions that are recognizable by the payment clearance system as a final order to transfer funds. The consumer is not initiating the transaction messages and sending it to the merchant, payment clearance system, or any intermediary server. It is the separation of instruction from actionable financial data and the role of the payment clearance system as the originator of payment instructions to the consumer that adds a level of security and control over the authorized movement of money. Furthermore, embodiments disclosed herein require two-step identification and authorization of the transaction to include factors such as the Mobile Identification Number (MIN), the Subscriber Identity Module (SIM) Card, Equipment Serial Number (ESN), International Mobile Equipment Identifier (IMEI) as well as user-based passwords or PINS.

### SUMMARY OF THE INVENTION

The invention, through its methods and systems, creates a network of participants, natural persons and various forms of organizations that are able to transact securely through a combination of wireless communications and wire line communications to and from mobile, fixed, non-fixed, and virtual devices. These transactions are facilitated through a payment clearance system.

Mobile devices including mobile phones, personal digital assistants, and other wireless devices that will emerge and have the ability to send to and receive messages from the payment clearance system are contemplated by the present invention. Fixed devices include POS terminals, cash registers, vending machines, tollbooths and other fixed devices that serve to collect payment and payment information for products and services. Non-fixed devices include terminals in taxis, buses, airplanes, and other moving merchants. Virtual devices include relationships and various mechanisms, e.g., on-line, bill printing, mailing, bill payment, remittance processing and as further discussed below, that exist between parties that typically relate to services being rendered requiring payment in arrears.

The methods and systems require the transaction request to be initiated by the merchant by requesting payment from a consumer through the payment clearance system.

The methods and systems serve to create account profiles for the various individual and organization based participants. These account profiles serve to identify and authenticate participants and capture authorizations for subsequent execution of transactions. The account profiles also serve as a transaction log that supports recording keeping, non-repudiation, and other information and compliance services.

The methods and systems identify and authenticate mobile devices through a combination of unique factors, one of which may include the Mobile Identification Number, (“MIN”), which is the mobile device number, the Equipment Serial Number (“ESN”) for CDMA based phones, IMEI (“International Mobile Equipment Identity”) for GSM based phones, SIM data for GSM based phones or other factors that are developed to uniquely identify a mobile communication such as radio frequency fingerprints.

The methods and systems capture consumer authorization by matching predefined codes in a consumer account profile to user-input codes from the mobile device. This method and system will serve as authentication of the transaction.

The methods and systems, uses a payment clearance system to generate payment instructions sent to the consumer mobile device, which authorizes, via the above-described methods, the transaction. The payment clearance system adds a level of security and control over authorized movement of money by not having the consumer initiating the transaction messages and sending it to the merchant. It is the separation of instruction from actionable financial data and the role of the payment clearance system as the originator of payment instructions to the consumer that adds the aforementioned level of security and control. Furthermore, the methods and systems may also require two-step identification and authorization of the mobile device to include device-based characteristics such as MIN, SIM Card, ESN, IMEI as well as user-based password or PIN.

Numerous other advantages and features of the invention will become readily apparent from the following detailed description of the invention and the embodiments thereof, from the claims, and from the accompanying drawings.

### BRIEF DESCRIPTION OF THE DRAWINGS

[15] A fuller understanding of the foregoing may be had by reference to the accompanying drawings, wherein:

FIG. 1 illustrates a consumer and merchant transaction system;

FIG. 2 illustrates a method in accordance to an embodiment;

FIG. 3 illustrates mobile-to-mobile transaction;

FIG. 4 illustrates fixed device/non-fixed device to mobile transaction;

FIG. 5A illustrates fixed device to mobile transaction with RF reader capability;

FIG. 5B illustrates a fixed device to mobile transaction when the mobile device is not present at the transaction;

FIG. 5C illustrates a fixed device transaction when the mobile device is not present or unavailable;

FIG. 6 illustrates an online transaction system; and

FIG. 7 illustrates a virtual transaction system.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or the embodiments illustrated.

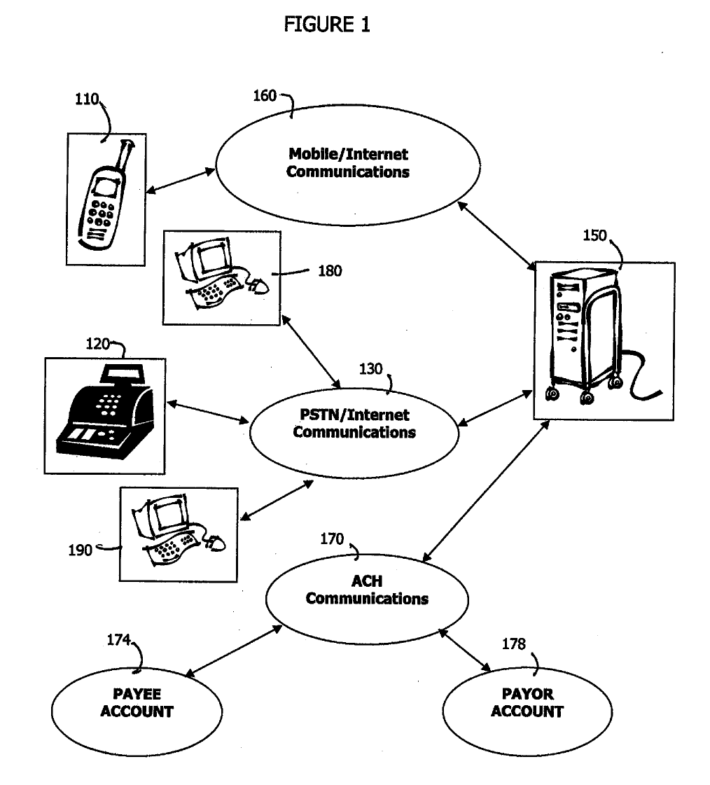

Referring now to FIG. 1, there is shown a first embodiment of the secure electronic transaction system 100 made between a mobile device and a fixed device. Such transactions are authorized by a mobile user 110, also referred to herein as the consumer (payer or the person making the mobile authorized payment), at a point of sale terminal 120 (referred to herein as POS terminal 120) found at a merchant. The merchant (or payee) is an entity to which payment is being made. The merchant POS terminal 120 would send a request for payment message through a cellular/PSTN/Internet Communication network 130 (or similar network, e.g. radio frequency) to a payment clearance system 150.

The payment clearance system 150 may include servers, databases to store information, applications, and communication means to enable the receiving and sending of wireless and wire-line telecommunications messages. The payment clearance system 150 may also be accessed through the internet and be in communication with a wireless (internet and/or cellular) networks for sending text and/or text/graphic messages (as discussed below).

The request for payment message would include information regarding the transaction, such as but not limited to, the Merchant Name, the amount owed, the date the transaction is being requested, and consumer information. In the prior art, consumer information would have included anything from the MICR information on a Check Information or credit/debit card. However, in this embodiment, the consumer information would simply be the mobile device 110 number associated to the consumer. (As well known in the art, the mobile device number permits a third party to send or place a call to that mobile device associated to the mobile device number.) The payment clearance system 150 would create and/or generate an authorization message based on the request for payment message and send the authorization message through a Mobile/Internet Communications Network 160 (or similar network) to the mobile device 110 for authorization. The Mobile/Internet Communications Network 160, known in the art, allows for the payment clearance system 150 to send and receive message from the mobile device. As explained below, the messages may be formatted as, but not limited to, short codes, SMS, EMS, MMS, WAP, XHTML, WML and other U.S. and foreign equivalents.

An acknowledgement message and/or authorization from the consumer on the mobile device 110 may simply be a returned message consisting of a muti-digit personal authorization code sent back through the Mobile/Internet Communications Network 160 to the payment clearance system 150. The payment clearance system 150 would check the received authorization against the consumer's predefined authorization code stored on a database accessible by the payment clearance system. If it matches, the payment clearance system 150 can generate and send a validation message to the merchant POS terminal 120 through the PSTN/Internet Communication Network 130, informing the merchant that the transaction has been authorized and payment will be effectuated in due course. Thereby allowing the consumer and merchant to conclude their transaction.

The payment clearance system 150 will then communicate with or through an ACH Communication Network 170 (or similar network) to begin the process of transferring funds from a consumer bank account 174 to a merchant bank account 178. In some instances the payment clearance system 150 with direct access to the consumer and merchant banks may handle the electronic transfer directly.

The payment clearance system 150 may be at secured location(s) to which information is stored regarding the consumer and merchant. The payment clearance system 150 will provide a secure web site in which a consumer at any internet connected computer 180 and a merchant at any internet connected computer 190 is able to access and create account profiles for an associated mobile device 110 or fixed, non-fixed or virtual devices (discussed in greater detail below).

The consumer account profile will include personal and financial data along with the establishment of an authorization password, PIN, or as mentioned above, authorization code. The authorization code is thereby predefined by the consumer or may be predefined by the payment clearance system as an initial random code but which is capable of being changed by the consumer. Initially the consumer will logon to the payment clearance system 150, probably through a website, and open a consumer account. The consumer enters information in order to set-up the consumer account which may include: personal information such as Name, Address, alternate Landline telephone number, a Username and Password for secure access to the Website, and security information such as date of birth or mother's maiden name. The consumer would also be requested to accept affirmatively various posted user agreement(s) for service and other required documents or policies.

The consumer will then enter secured information regarding the checking account against which ACH or other transactions will be debited or credited. This information includes name of the account and the 9-digit transit routing number. The payment clearance system 150 may perform a Modular Ten check to validate the structure and a Thompson check to validate that it contains a valid ABA number. The payment clearance system 150 may create and present an image of a check to help with the validation. Additional information may include a credit or debit card account and expiration data that will be kept on file and used for incidental charges, such as payment (and penalty) to a third party or the owner of the payment clearance system 150 for funding a failed transaction. The credit or debit card may not be positioned as an unlimited backstop but will only be used a finite number of times before the account is closed, e.g., 3 times in 6 months. Additional information may also be requested such as Social Security number. All of the information may further be linked to a mobile device number and finally to the authorization code (multi-digit and alpha-, numeric, or alphanumeric—ideally something easy to input into his or her mobile device key pad). Future embodiments may include voice activation authorization codes or biometric scans into the mobile device itself.

The consumer account will be activated through the delivery and response of a real-time message to the mobile device 110. All such messaging to and from the mobile device 110, disclosed herein, may be a SMS (Short Message Service) message. Alternatively, other types of messaging services may be used such as but not limited to EMS (Enhanced Message Service) which enables the delivery of richer content, e.g, icons, sounds; MMS (Multi-Media Message Service) which has even more bandwidth but has very limited availability right now. As such, the text-based messaging described below could be replaced by audio and video messages overtime or as necessary. Other alternatives to using the above messaging services is using an instant messaging program, on the mobile device. This can be in the form of software that's pre-installed on your mobile device, or by accessing from your mobile device.

Upon entering the information, the payment clearance system generates an initial message using the data just provided. The initial message includes instructions to reply, maybe with the authorization just established or with a randomly generated sequence. In this initial message the consumer is prompted not to save the message and in the event the mobile device's default mode is to save messages, the consumer is prompted to change the setting to prompt for decision on NOT to save messages. A complete log of all transactions will be available on the payment clearance system web site through a secured access.

Following from the initial message, the consumer replies to the payment clearance system 150, which receives the replay message, matches in-bound messaging number/address with one it used to send the message, which is the one entered into the account profile. The payment clearance system 150 then matches the authorization code from the consumer account profile or the random code. The payment clearance system may also capture the MIN, ESN (if a CDMA phone), IMEI if it is a GSM phone, data from the SIM card—also for GSM phones, and/or the radio frequency (“RF”) finger print of the mobile device and link any and all this data to the consumer account profile. Collectively, this process serves to associate the consumer to the mobile device and the account profile. When a consumer changes mobile devices and keeps the same mobile device number and/or the SIM card, the payment clearance system 150 will automatically update. If not, the consumer may need to go back to website and re-authenticate the new mobile device. After authorization the consumer receives a message from the payment clearance system that the account is activated.

From a data perspective, all the account and user information preferably occurs with secure protocols and algorithms and data is then further encrypted in a database server, defined by the payment clearance system 150. From a payment processing perspective, the various mechanisms of MIN, ESN, IMEI, SIM, RF fingerprint serve to authenticate the consumer while the authorization code is used under the electronic signature rules to authenticate, and/or authorize the transaction. From a security perspective, at no point does any personal financial or security data ever get transmitted again. Even access to it can be limited to a few administrators. All service and reporting will be performed off of sanitized and truncated data. Financial settlement through the ACH network 170, internal bank transfer, and, on occasion through the merchant card acquirer, will occur over secure connections to as few financial counterparties as prudent, e.g, one bank and one merchant acquirer, or may be a single bank acquirer. It is contemplated by the present embodiments that other security systems may be employed without affecting the scope of the invention. The security measures are mentioned simply to alleviate concerns regarding the safety of financial and personal information.

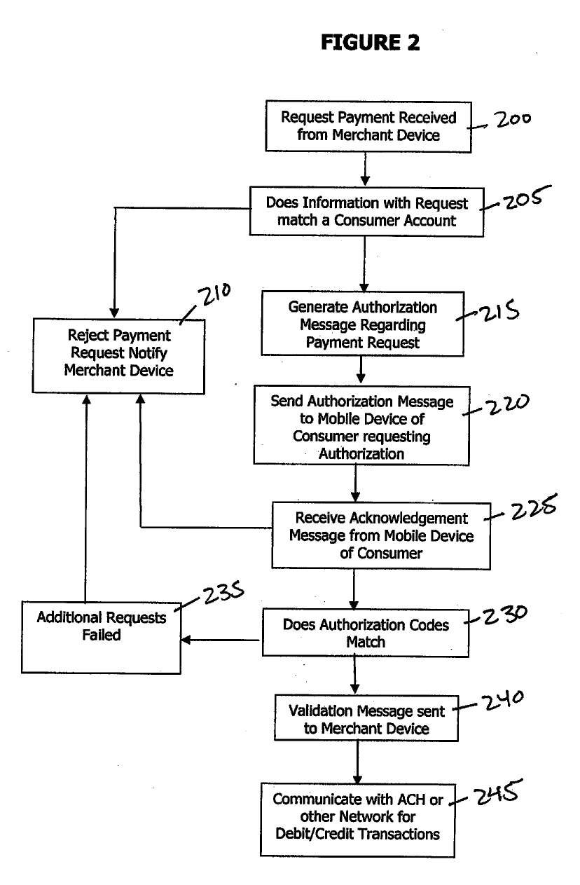

Referring now also to FIG. 2, there is shown a method in accordance with the first embodiment illustrated in FIG. 1. Initially a payment request sent by a merchant device 120 is received by the payment clearance system 150, Box 200. The merchant device 120 while initially referred to as a point of sale terminal may be any type of fixed (i.e. POS terminal, vending machine, toll booth), non-fixed (devices found in taxis, buses, trains, planes or any other mobile service device) or virtual (ads, online, billboards, short code sales) merchant device. The payment clearance system 150 will check the information sent in the payment request against its accounts to match the information to a consumer profile, Box 205. Should the information not match against any account, the payment clearance system 150 will reject the payment and notify the merchant device that the information does not match an account, Box 210. This may occur if the mobile device number associated to the mobile device of the consumer is entered incorrectly by the merchant. Alternatively, if the payment clearance system does not match the mobile device number and determines it is a new user, the payment clearance system may generate a set-up message and send it to the mobile device of the consumer. The set-up message could ask for specific initial information to quickly set-up an account. The initial information may include authorization code, and bank account and/or credit card information. Allowing the transaction to commence and requesting the user to logon to the payment clearance system website later to provide additional information.

If a consumer account is located or after an account is set-up, an authorization message regarding the payment request is generated by the payment clearance system 150, Box 215, and sent to the mobile device associated to the consumer, Box 220. The authorization message requests an authorization from the consumer. Preferably, the mobile device 110 receives the authorization message (in one of the forms mentioned or even a Flash SMS). The authorization message will contain a standard set of information including but not limited to (1) a “From” header with the name of the payment clearance system, (2) the name of merchant requesting payment in the body of the message (the merchant name may also be a mobile device number or alias of another mobile user for consumer-to-consumer payments, or it may be an established acronym of the merchant); (3) the amount due in dollars and cents; (4) the date and time; (5) a salutation (optional); and/or (6) order or tracking number (optional).

The payment clearance system then waits for an acknowledgement reply message from the consumer authorizing the transaction, Box 225. The acknowledgement message from the consumer would be a reply from the mobile device 110, preferably with the authorization code (or PIN). The acknowledgement message is sent back to the payment clearance system 150. When the acknowledgement message is received by the payment clearance system 150, it is checked against the consumer account, Box 230. The payment clearance system may also match its outbound message with the reply by MIN, ESN/IMEI/SIM/or RF Fingerprint stored in consumer profile. The payment clearance system will match the authorization code against the predefined authorization code stored in the consumer profile. Authentication, authorization, and logging of all data are done at and by the payment clearance system 150. If the acknowledgement message is not received, the payment clearance system may reject the payment request, Box 210. This may occur after a predetermined amount of time has past.

If the authorization codes do not match, the payment clearance system 150 may, alternatively, request an additional authorization, giving the consumer the opportunity to correct a mistake, Box 235. However, eventually if the authorization codes do not match, the payment clearance system will reject the payment request, Box 210. If the authorization codes match, a validation message is generated and sent to the merchant device, Box 240, such that the merchant may finalize the transaction. Additionally, the payment clearance system may send a validation message to the mobile device of the consumer informing the consumer that the request was validated.

The payment clearance system will then communicate with an ACH network or other network, which may be an internal bank system, to debit/credit the merchant/payer bank accounts, Box 245. This may occur later in the day or week or occur right after the validation message(s) is sent to the merchant device and the mobile device of the consumer. The payment clearance system originates ACH debit (WEB or PPD) from the bank account stored in the consumer profile for the authorized amount. The payment clearance system originates a corresponding ACH credit (PPD or CCD) for the authorized amount (less agreed upon transaction fee) into the merchant bank account associated with the merchant profile—natural person or otherwise from a corresponding payment clearance system bank account. The transaction may also occur internally within a bank using an account transfer. In the event the ACH debit fails, the payment clearance system will resubmit it to the ACH system the maximum amount of times to optimize clearing. The payment clearance system may also send a message to the mobile device of the consumer notifying him of the situation.

If debit continues to fail, the payment clearance system having a credit card authorization from the consumer may charge the credit card on file in the consumer profile for the amount plus a processing fee. This process provides guaranteed funding to the merchant and ultimately guaranteed funding to the payment clearance system to offset. In situations where a consumer credit card is charged, the payment clearance system will use an intermediary account associated to the payment clearance system for the transfer of funds. Thus, the merchant will receive funds directly from the payment clearance system intermediary account and the consumer will see a charge on its credit card to the payment clearance system. This helps to guarantee the funding to the merchant and helps eliminate any disputes between the consumer and merchant regarding the charges.

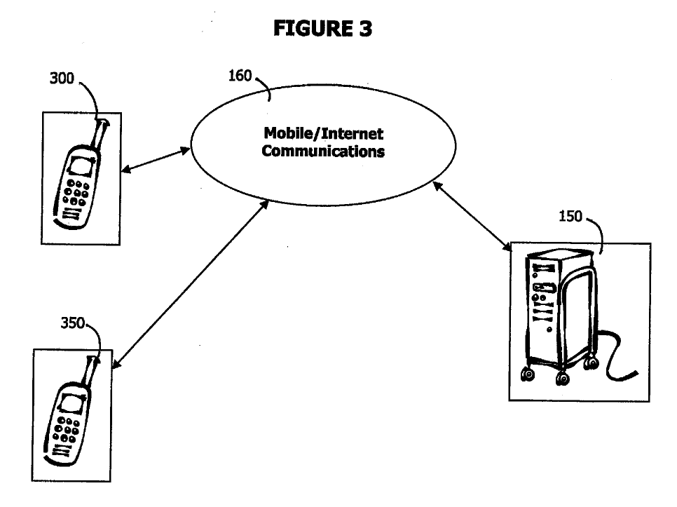

Referring now to FIG. 3, for a consumer-to-consumer payment between two mobile devices, a first user 300 makes a request to transfer money to a second user 350, both of which are using mobile devices 300 and 350 (respectively). The first user 300 sends an initial message to the payment clearance system 150 via the mobile/internet communication networks 160 using a pre-established message code for consumer-to-consumer payments. The message would include the mobile device number of the second user 350 in the body of the message, along with the amount to transfer in dollars.cents. The payment clearance system will preferably have flexibility to account for double spaces, the inclusion of a “$”, the omission of cents, but any number that falls out of range of dollar limits or is unrecognizable due to alpha characters or too many significant figures will not be processed and a message sent back to the first user 300 to that effect. Additional information or other information may be utilized in the message such that a predefined alias' or short name may be used rather then the mobile device number. A request for payment message will be generated by the payment clearance system 150 and sent back to the first mobile device 300 number, along with additional information that was part of the initial message. The information may include the amount to transfer, the second mobile device 350 number or alias or name, and date. The first mobile device 300 receiving the message would have to reply to transfer the funds along with an authorization code, or a reply not to transfer. The payment clearance system 150 would validate the authorization code and generate and send messages to the first mobile device 300 and the second mobile device notifying the two of the transfer or failed transaction. The payment clearance system 150 will then communicate with the banking networks to make the appropriate transfers.

Additionally, the first mobile user 300 may request to transfer money from a second mobile user 350. This embodiment is slightly different than the previous embodiment, in that the request for transfer would be sent to the second mobile user 350 for authorization as funds are being debited from the second user's bank account.

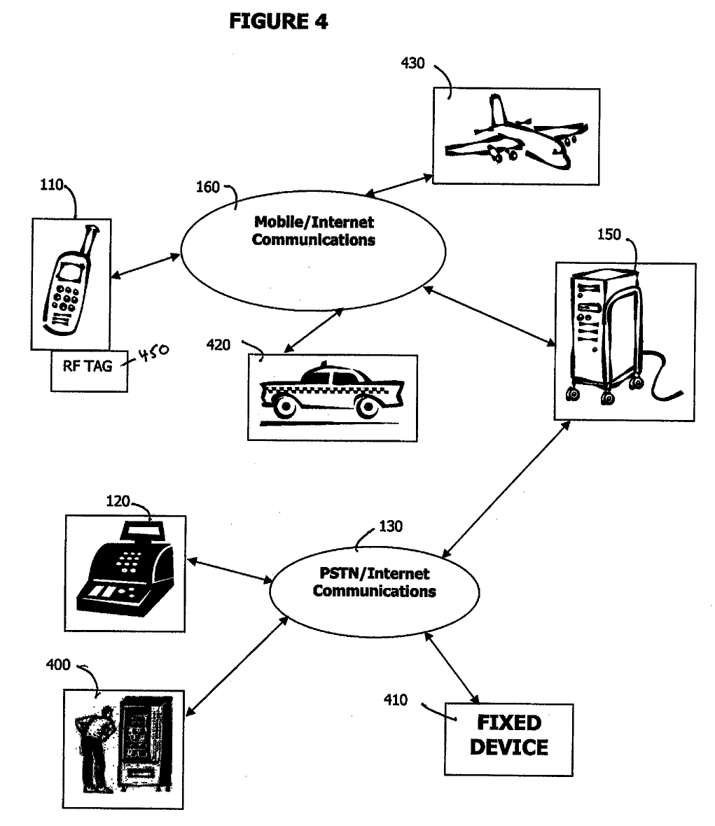

Referring back to FIGS. 1 and 2 and to FIG. 4, for the payment to a merchant with a fixed device or to a mobile device, the following procedure or process may be followed. In this case the fixed device may be a point of sale terminal/cash register 120, a vending machine 400, or other type of fixed device such as a tollbooth or phone both (referred to generally as 410). These devices may also be referred to as a receive-payment-only device. The merchant may also be the owner of a non-fixed device such as but not limited to a taxi 420, airplane 430, or other moving merchant device. The term merchant generally describes any owner of a fixed device, non-fixed device or virtual device (explained in greater detail below).

The merchant will create an account with the payment clearance system 150 that will provide the bank transit routing number into which funds from purchases are to be deposited, a merchant bank/depository account. The merchant will be provided or will establish a username and ID for his web-based account from which he will be able to access all transaction information associated with his POS terminal, store, region or enterprise. The merchant profile capability within the payment clearance system will allow for the complex reporting needs across varying types of merchants, as long as the fixed device is online. It will enable reporting from the enterprise down to the cash register and then down to the cashier on that register for stores that run multiple shifts. The payment clearance system will preferably establish a contract with the Merchant of the POS terminals for payment services. Terms and conditions and pricing will be standard and based on transaction and dollar volumes. Implementation fees will vary by number and type of POS devices.

All, if not most, POS terminals 120 are TCP/IP enabled and operate within a PSTN/Internet Communications network 130. The POS Terminal 120, through TCP/IP, will have a secure connection through the network 130 to the payment clearance system. Through the secure TCP/IP connection, key pieces of data can be passed to the payment clearance system. The merchant name, amount due, mobile device 110 number of consumer, an assigned ID for PO terminal (if desired—recommended). As an option, the merchant could send along an indicator for alcohol/tobacco. This data along with the mobile device 110 number could verify age and prevent unlawful purchase. Messages would be sent back to the POS terminal 120 indicating such age or any additional information. Perhaps even picture ID of the mobile device owner if the messages included images.

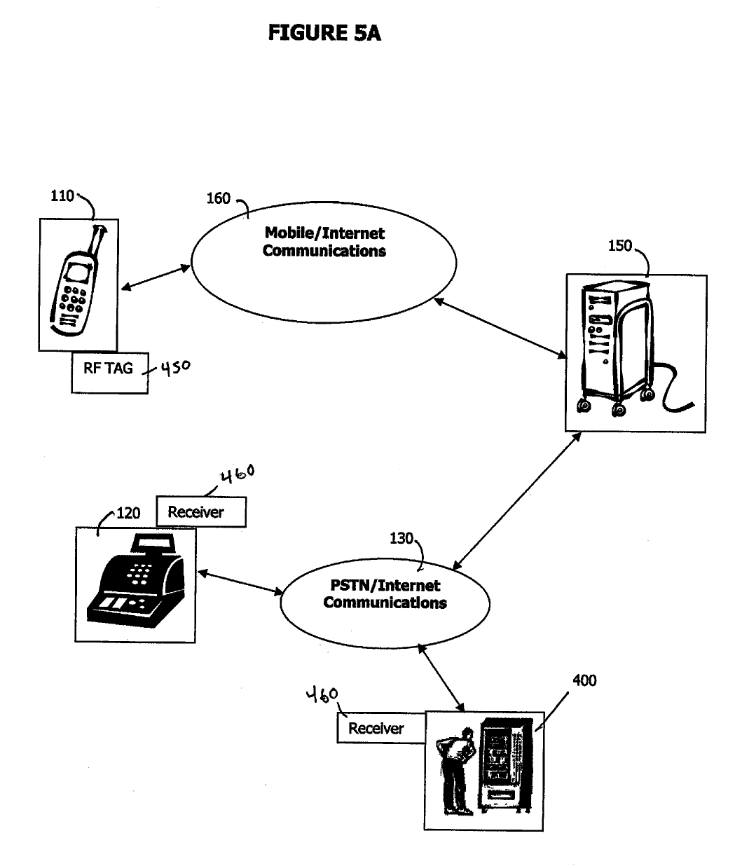

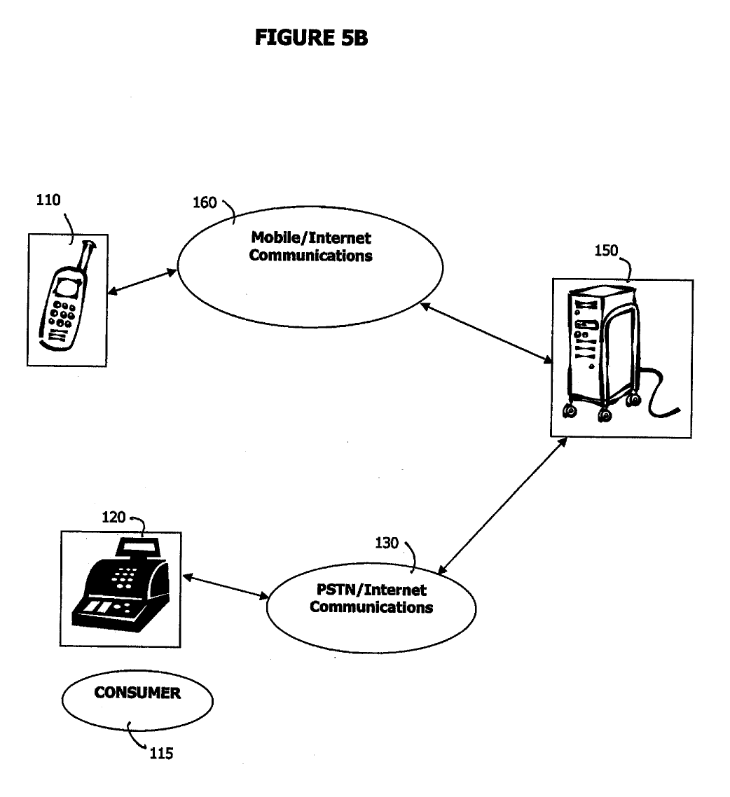

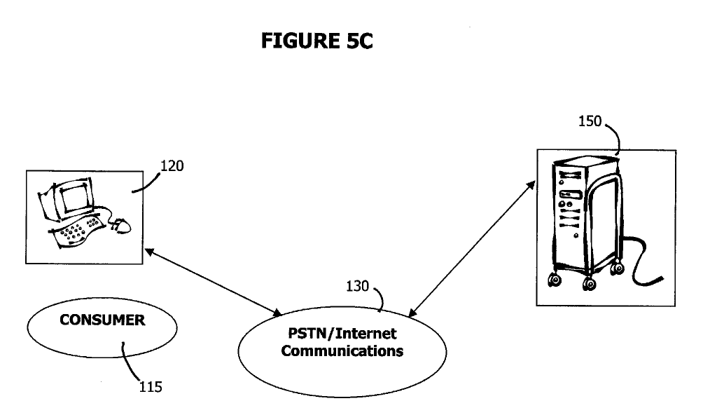

Acquiring the mobile device 110 number may be done a few ways. Initially the cashier or the merchant operating the fixed or non-fixed device will enter it into the message that will be sent to the payment clearance system 150. Illustrated in FIG. 5A, the mobile device 110 may also contain a passive radio frequency tag 450 that a short range RF transceiver 460 will be able to capture systematically. This data will be sent to the payment clearance system that will be able to generate a payment message that will include merchant name, amount due, salutation all of which will fit into the request for payment message. This may occur over the already described networks or via close range wireless networks, e.g. radio frequency.

In addition, with the current investment in passive RF tags for inventory control, merchants will create cashier-less checkouts and capture incremental value for this investment. A consumer in the process of exiting a store will pass through a RF reader that will tally up the value of all the goods in the shopping basket as well as read the mobile device number of the purchaser. This data will be transferred to the payment clearance system, which will send a request for payment message to the consumer.

An alternative embodiment, illustrated in FIG. 5C, the payment clearance system 150 permits the purchasing or transaction to commence between an internet based merchant 120 and a consumer 115, without the use of the mobile device. For example, the consumer may not have his mobile device with him when purchasing. In this case, the consumer can enter his mobile device number and will be prompted by the payment clearance system to enter additional, authorizing data to complete the transaction. This combination of unique information is matched against the pre-existing information in the payment clearance system. The payment clearance system authenticates and authorizes the transaction and logs the transaction in the consumer account profile.

In an alternative embodiment, illustrated in FIG. 5B, the payment clearance system permits the purchasing or transaction to commence between a merchant 120 and a consumer 115, even when the consumer does not have the mobile device 110. For example, a consumer (such as a child) does not have to be given money or a credit card by the child's parents. The child can simply provide the mobile device number of the parent. The merchant 120 will communicate the information to the payment clearance system which would send the request for payment message to the mobile device. The parent viewing the message can authorize and acknowledge the request for payment with the appropriate authorization code. The payment clearance system will validate the transaction and send the appropriate message and information to the merchant 120. The child 115 can then conduct a transaction.

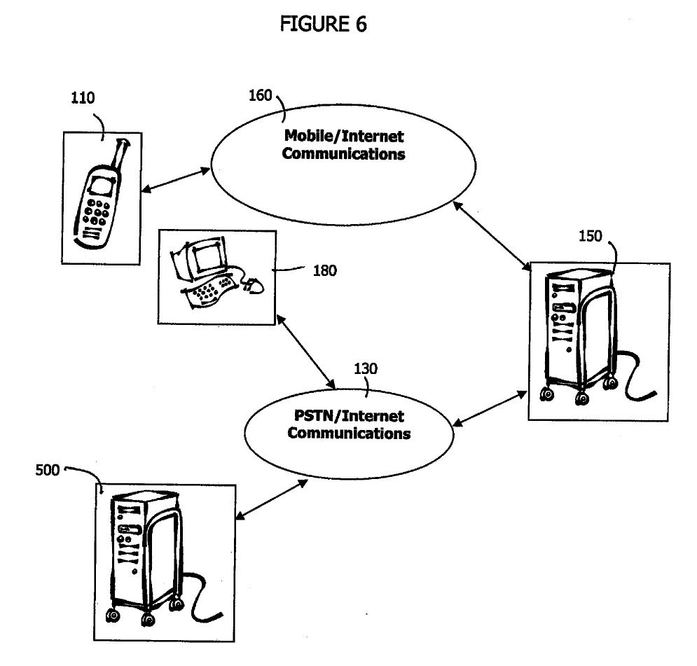

Referring now to FIG. 6, for merchants that fall into the Mail Order/Telephone Order (“MOTO”) or Internet Order, they would contract with the payment clearance system, provide depository account data and establish a secure link via secure IP from their order entry application server 500 to the payment clearance system 150 to the MOTO. The consumer using its own terminal 180 would then provide or enter a mobile device number 110. At the point of order completion, a request for payment message would be session-transferred from the MOTO to the payment clearance system 150. The message would include amount due, and may include order number, or agent number and mobile device number. The payment clearance system would then generate and send an authorization message to the mobile device with merchant name, amount due, and salutation. The consumer would send an acknowledgement message that may include an authorization code. The payment clearance system would receive, and authenticate the acknowledgement message and send a validation message via TCP/IP to the merchant and send a validation message to the consumer (which could be a message to the mobile device number and/or an email associated to the consumer).

The validation message to the merchant could include shipping address data of the consumer, as long as it is the same address as provided for in the consumer profile. Financial data, credit card or otherwise, is never communicated or transmitted. Making the e-commerce transaction more secure for the consumer as they never have to release there financial or personal information to the merchant.

In a tollbooth situation, the payment clearance system would work along similar processes and be accomplished by affixing a low cost device, linked to drivers mobile device number, capable of being “read” by the tollbooth. This would reduce the cost of the current device, eliminate the need for consumers to create an account or otherwise periodically pre-fund their toll account. The tollbooth would consist of simple device; similar to those in current use, but would capture the mobile device number, link it to the amount due, send it over secure IP to the payment clearance system that sends a toll message to the driver. The payment message does not need an immediate reply, to avoid driver distraction. The messages could also be set up to sent in batch. The existing compliance mechanisms will be used to identify non-payers.

Additional embodiments are also included, such as a two-factor authentication of a person. Application of this, outside of financial transactions, may include, but not be limited to, (1) gaining authorized access to building, arenas, and similarly restricted areas, (2) receiving a delivery package that previously would require a written signature, (3) remotely authorizing a contract, e.g., a mortgage, that previously required a written signature, (4) added authentication at passport control or any other situation that requires authentication. In these situations the person can send a pin or authorization code over the mobile device to the payment clearance system, which has an established relationship and secure connection to the building or personnel running the restricted area or to the other party requiring the authorization or authentication. This can save time, money, and effort because the person's personal information is attached to the authorization code via the payment clearance system which verifies the person through the authorization code and mobile device number. The payment clearance system may in these situations send to the building, restricted area or other party, a confirmed authentication of that person and or other personal information such as name, address, date of birth, and even a picture or photo of the person for visual matches. In terms of advantages over existing mechanisms, such security badges, and written signatures, the payment clearance system will be able to deliver a higher degree of security due to the two factor authorization, be less subject to fraud and be delivering at a lower ongoing expense.

Referring back to FIG. 5A, a vending machine vendor will establish a contract and create a depository account into which the payment clearance system will have access for depositing funds. The vendor will establish a username and password to enter his secure web site to access transaction data by machine, region, or other hierarchy. Vending machines 400 have power but some are not online and not connected by IP. For those that are connected accounts and connectivity will be set-up by securely connecting the machine to the payment clearance system and assigning it a unique ID. The machines will then need to be able to capture the mobile device number of the purchaser. This may be accomplished by a keypad and/or RF reader 460. The vending machines 400 will also need to be set-up to release product, lift gate, or dispense ticket, etc. by receiving confirmation of payment, which will be accomplished by the payment clearance system sending a message to the vending machine. The vending machines that are not online will require TCP/IP connectivity or alternatively, a form of near field communication, e.g. RF. Unlike the tollbooth, these communications will need to be real time.

For the use of virtual devices, such as enabling bill payments by interfacing with an account receivable system or billing companies, all generally referred to as Billing Provider, the Billing Provider would contract with the payment clearance system to enable the delivery of a message based notice that would be a short version of the full bill. The payment clearance system will provide a web-based service, linked with the billing entity's web site, in which the consumer would elect to receive a message billing notice and correspondingly make payment. The payment clearance system, via a (secure) session transfer from the billing client, will capture the consumer's account number and mobile device number. Consumer will already have a consumer profile or could be prompted to create one, either by responding to a set-up message or by using a hyperlink. The payment clearance system will store those two pieces of data and via web service or receiving a file transfer create and deliver a message bill to the consumer. Consumer will receive bill message from the payment clearance system and confirm payment. The payment clearance system will execute financial settlement. In conjunction with the settlement, the payment clearance system will provide the billing entity the necessary remittance detail, e.g., the account number, with which the billing entity will post/apply the credit to the internal billing system.

or enabling a new interactive form of transaction between a

In an interactive payment process, a such as the transaction between a mobile purchase and an advertising, television show, movie, charity fundraiser, an entity seeking to receive funds can publish a a product code that corresponds to the desired purchase, donation, subscription, service, etc., along with a short code corresponding to the payment clearance system. The product codes are leased by the payment clearance system and assigned to the merchant, charity, entity, etc. and correspond to the advertised or published offering. The consumer, who already has an account with the payment clearance system, sends a message to the short code identifying in the message a specific product code. The message goes to the payment clearance system that correspondingly formats an authorization message describing the offering, the amount, the merchant and seeks confirming payment reply, e.g, United Way Donation, $50.00, Thank You. Product codes could be assigned to products in a catalogues, infomercials, ads, etc.

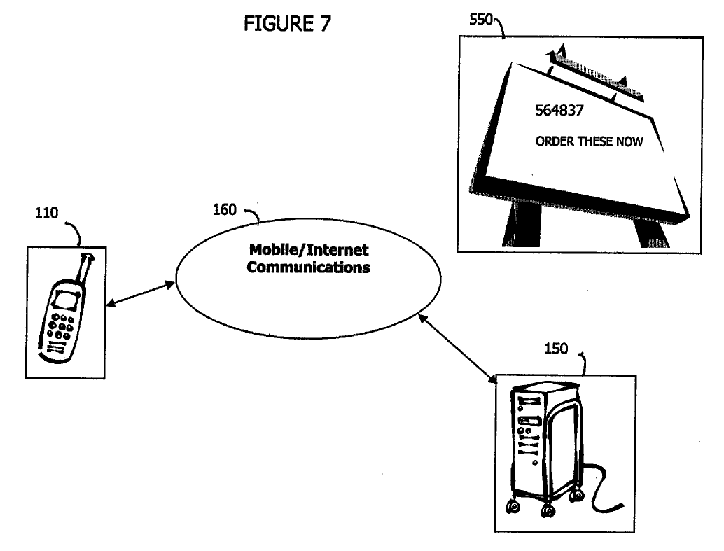

The payment clearance system will have established relationships with these providers, an account into which funds are deposited and a full recording of every transaction and could, when necessary or appropriate, provide shipping address. Illustrated in FIG. 7, the consumer of mobile device 110 messages 564837 to order a set of advertised steak knives that is published on a billboard 550, but may also or alternatively appear in a newspaper, magazine, on television or on the Internet. An authorization message is generated and sent from the payment clearance system 150 with merchant name, amount due, and salutation to the mobile device of the consumer. The consumer acknowledges the transaction with an authorization code and the payment clearance system sends confirmed order, payment, and shipping details to merchant. The payment clearance system then settles the payment.

Other embodiments include the settling of financial transactions using financial settlement tools that enable a real-time verification of funds, e.g. via ATM/POS debit networks or card association networks, e.g., Visa POS, as well as enable the real time settlement of funds via mechanisms such as wire transfer or others that may be developed over time.

The payment clearance system can also track and provide loyalty reward programs for its merchant and consumer users. By tracking all actions on both sides of the transaction the payment clearance system is uniquely positioned to provide data to enable loyalty programs as well as provide them. Merchants will have an option to opt into the company's loyalty program for an incremental transaction fee. The payment clearance system will negotiate directly, on behalf of its collective loyalty merchants, with various reward providers, e.g., hotels, airlines, other merchants, and track usage by merchant and tally the consumer's total merchant loyalty points. This program will allow merchants to pay more to give more points to consumers using their establishment. The consumer will be able to log onto their secure account profile and view their total point summary by merchant. Merchants may elect not to participate. This program is unique in the flexibility it provides the merchant and in the control it gives the merchant. The payment clearance system will enable its own loyalty program that will track and reward usage by the mobile user in addition to the merchant-directed programs.

Other embodiments include for cross-border and international payments. Most messaging services are already a global standard along with the use of device authentication. In a similar fashion to U.S. domestic payments, these payments will be enabled through the company's connection to appropriate financial partners to facilitate settlement, e.g., Wells Fargo can settle cross-border in Canada, Mexico, Europe, Australia, New Zealand, and in accordance which local rules, regulations, etc.

In addition to the methods already described a consumer may conduct a transaction via his mobile device by payment authorization via a Mobile Web. The transaction may be conducted by the following steps: (1) An message containing transaction information and instructions is sent over a Signaling System 7 (“SS7”) or SMS network; (2) Included in that message, along with transaction information, is an embedded http link, e.g., http://mpayy.com; (3) Included in this link will be a range of additional data including but not limited to, e.g., authentication credentials, reward points, coupon discounts; (4) The mobile device, upon receiving the message, will interpret the link and open up a mobile web browser to the web page associated with the embedded link. This may happen in a variety of ways depending on consumer preference and mobile device design. Among the ways include (1) an automatic launch upon the successfully delivery of the message, (2) a single key stroke that opens the message which in turn automatically opens the web browser or (3) a key stroke to view the message and then a key stroke or more to open the browser; (5) The browser will open up to a small Wireless Markup Language (“WML”)/Extensible Hypertext Markup Language (“XHTML”) web page, e.g., the embedded link. On that web page will be information and input options related, directly and indirectly, to the transaction. Allowing the consumer to enter in an authorization code at that time.

The above embodiments provide for various methods and systems, some of which are briefly presented herein below. An embodiment for enabling and executing secure electronic transactions between parties via fixed, non-fixed, virtual, and mobile devices through a payment clearance system serving as a central, secure information clearinghouse, transaction counterparty, and settlement agent. An embodiment in accordance with any of the above where the payment clearance system serves to capture, store, send, and receive data, e.g., financial data, user agreements, and operating policies, established and transmitted by the parties and uniquely associated with the fixed, non-fixed, virtual, and mobile devices and the parties to effectuate the electronic transactions by receiving, processing, and transmitting instructions. An embodiment in accordance with any of the above where the payment clearance system sends and receives data from various third parties, e.g., financial settlement systems, statistical analysis systems, regulatory organizations, to effectuate the transactions, programs, and campaigns. An embodiment in accordance with any of the above where the payment clearance system systematically captures, tracks, and manages data for the purposes of supporting various marketing, user-loyalty, compensatory, transaction non-repudiation, legal compliance programs, and campaigns. An embodiment in accordance with any of the above where a mobile device is uniquely identified via its Electronic Serial Number, (“ESN”), Subscriber Identity Module (“SIM”) card, International Mobile Equipment Identifier (“IMEI”), Mobile Identification Number (“MIN”)—the mobile device number—or other unique characteristics of mobile devices that evolve over time as part of the communications industry's continued progress toward the elimination of fraudulent use.

An embodiment in accordance with any of the above where a fixed, a non-fixed, and/or a virtual device is uniquely identified via an assigned number that may include an Internet Protocol (“IP”) address, IP session transfer variables, and/or serial number. An embodiment in accordance with any of the above where a party to the fixed, non-fixed, or virtual device is assigned a unique code that may include IP session transfer variables.

An embodiment in accordance with any of the above where the consumer of the mobile device is uniquely identified via a previously establish, securely stored password or authorization code, which may be alphabetic, numeric or alphanumeric, voice recognition, or thumb print recognition within the computer application.

An embodiment in accordance with any of the above where the fixed, non-fixed, or virtual device may capture unique identifiers, for the purpose of initiating a transaction, of the mobile device via manual data entry on the fixed, non-fixed, or virtual device or through radio frequency or other non-manual process on the fixed, non-fixed, or virtual device.

An embodiment in accordance with any of the above where the consumer of the mobile device is uniquely identified and authorized to initiate transactions through the payment clearance system via the ability to decrypt an encrypted instructions through an application residing on the mobile device.

An embodiment in accordance with any of the above where the devices and payment clearance system can be used to effectuate non-United States electronic transactions as well as cross international border electronic transactions.

An embodiment in accordance with any of the above where the electronic transactions are financial payments, where the payment clearance system acts as common counterparty, authorization agent for all parties, and as originator of instructions to financial settlement systems, e.g., NACHA.

An embodiment in accordance with any of the above where the financial payments are securely conducted without the transmission of financial data between the devices and payment clearance system. An embodiment in accordance with any of the above where the financial transactions are conducted between a mobile device and a fixed, unattended device, e.g., vending machine, tollbooth.

An embodiment in accordance with any of the above where the financial transactions are settled, first, through bank account transfers and in the event the bank account debit is not successful after multiple attempts due to insufficient funds or other reason, merchant is still credited and the consumer's credit card on file is charged. In this embodiment, the merchant may not be directly or immediately funded by the consumer's credit card but by an account associated with the payment clearance system. Successive failed payer debits over a specified amount of time will lead to the closure of the consumer profile and account.

An embodiment in accordance with any of the above where the transactions may be originated through provision of a text message and corresponding code to instigate creation of a transaction, e.g., payment request, to the mobile device. The code could be published on a bill board, catalogue, web site, commercial, or television show seeking donations. The code, which may be temporary, corresponds to a dollar amount and possibly a product. The consumer using a mobile device sends a message, with the code, to the payment clearance system, preferably by short code. A new message is sent to the mobile device identifying the merchant or organization, the dollar amount and a request for confirmation. This could also be used to purchase goods and merchandise whereby such goods or merchandise are delivered to the consumer's home or business address in the consumer profile. An embodiment in accordance with any of the above for which ordering, payment, and delivery information are captured and executed simultaneously.

From the foregoing and as mentioned above, it will be observed that numerous variations and modifications may be made without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

I claim:

1. A payment clearance system for authorizing and clearing a transaction between a consumer and a merchant, the system capable of receiving and sending messages over mobile, wire-line, and/or internet communication networks, the system further comprising:
application means, wherein when a request for payment message is received from a merchant device for a payment on said transaction between said consumer and said merchant, said application means extracting from said request for payment message information relating to a mobile device associated to said user,
said application means further generating an authorization message relating to said request for payment message and further sending said authorization message to said mobile device,
wherein when an acknowledgement message is received from said mobile device authorizing said transaction, said application means generating a merchant validation message and further sending said merchant validation message to said merchant device authorizing said transaction.

2. The system of claim 1, wherein when said application means generates a consumer validation message authorizing said transaction and further sending said consumer validation message to said mobile device of said consumer.

3. The system of claim 1 further comprising a storage means storing a consumer profile corresponding to said consumer, said consumer profile including information associated with a consumer bank account, said storage means further storing a merchant profile corresponding to said merchant, said merchant profile containing information associated with a merchant bank account.

4. The system of claim 3, wherein said application means communicates with a banking network for an electronic transfer of funds from said consumer bank account to said merchant bank account.

5. The system of claim 3, wherein the storage means further storing in said consumer profile a predefined authorization code, and wherein when said application means receives said authorization message, said application means extracting from said authorization message a consumer entered authorization code, and said application means comparing said consumer entered authorization code to said predefined authorization code stored in said consumer profile and wherein when said consumer entered authorization code matches said predefined authorization code, said application means authenticating payment of said transaction by generating and sending said merchant validation message.

6. The system of claim 5, wherein when said consumer entered authorization code does not match said predefined authorization code stored in said consumer profile, said application means further generating a second authorization message and further sending said second authorization message to said mobile device.

7. The system of claim 5, wherein when said consumer entered authorization code does not match said predefined authorization code stored in said consumer profile, said application means generates a reject transaction message and further sending said reject transaction message to said merchant device.

8. The system of claim 1, wherein said merchant device is a point of sale terminal.

9. The system of claim 1, wherein said merchant device is a fixed device, non-fixed device, or virtual device.

10. The system of claim 1, wherein the application means generates and sends messages to said mobile device based on a SMS, an EMS, and/or an MMS messages.

11. The system of claim 1, wherein the acknowledgement message is based on a SMS, EMS, MMS, or mobile web message.

12. The system of claim 1, wherein the application means extracts information from said request for payment message and application means further including said extracted information into said authorization message.

13. The system of claim 1, wherein the extracted information related to said mobile device from said request for payment message is a mobile device number associated to said mobile device.

14. The system of claim 3, wherein the extracted information related to said mobile device from said request for payment message is a RF fingerprint of said mobile device and said storage means storing in said consumer profile said RF fingerprint and an associated mobile device number.

15. The system of claim 1, wherein the application means further tracking and reporting all transactions made by said consumer and/or transactions made to said merchant.

16. The system of claim 4, wherein said storage means further storing in said consumer profile information associated with a consumer credit card account, and said application means further communicating with a network for an electronic transfer of funds from said consumer credit card account when said application means receives a message through said banking network indicating said electronic transfer of funds from said consumer bank account to said merchant bank account failed.

17. A method for authorizing and clearing a transaction between a consumer and a merchant, the method comprising:
receiving a request for payment message sent to a payment center from a merchant device based on said transaction, wherein the request for payment message includes information associated with said transaction and information relating to a mobile device associated to said consumer;
generating an authorization message from said payment center requesting authorization from said consumer of said transaction;
sending said authorization message to said mobile device associated to said consumer;
receiving an acknowledgement message sent to said payment center from said mobile device in response to said authorization message;
generating a merchant validation message from said payment center in response to said received authorization message and sending said merchant validation message to said merchant device authorizing said transaction; and
launching from the payment center a payment procedure relating to said transaction to transfer funds from a user bank account to a merchant bank account.

18. The method of claim 17, generating a consumer validation message from said payment center in response to said received authorization message and sending said consumer validation message to said mobile device authorizing said transaction.

19. The method of claim 17, wherein upon receiving said authorization message, the method further including the steps of extracting from said authorization message an authorization code entered by said user, comparing said authorization code against a predefined authorization code associated to said user, and when said authorization code matches said predefined authorization code, generating and sending said merchant validation message.

20. The method of claim 19, wherein when said authorization code does not match said predefined authorization code, generating a reject transaction message from said payment center and sending said rejection transaction message to said merchant device.

21. The method of claim 17, wherein said generated messages includes generating a SMS, EMS, MMS, or a web based message.

22. The method of claim 17, wherein the information relating to said mobile device is a mobile device number.

23. The method of claim 17, wherein when the information relating to said mobile device is an RF fingerprint, the method including the steps of comparing said RF fingerprint with pre-stored information associated to said consumer and obtaining within said pre-stored information a mobile device number corresponding to said RF fingerprint.

24. The method of claim 17, wherein when the information relating to said mobile device is an unique identification associated to said mobile device, the method including the steps of comparing said unique identification with pre-stored information associated to said consumer and obtaining within said pre-stored information a mobile device number corresponding to said unique identification.

25. A payment clearance system for authorizing and clearing a transaction between a user and a participant, the system capable of receiving and sending messages over mobile, wire-line, and/or internet communication networks, the system further comprising:
an application means, which when a transaction request message relating to said transaction is received from a mobile device associated to said user,
said application means generating an authorization message in response to said request message and being capable of sending said authorization message to said mobile device, and
wherein when an acknowledgment message is received from said mobile device, said application means generating a participant validation message and said application means further sending said participant validation message to said participant.

26. The system of claim 25, wherein said application means further initiating an electronic transfer of funds from a user bank account associated to said user to a participant bank account associated to said participant.

27. The system of claim 26 further comprising a storage means for storing information associated to said user and for storing information associated to said participant.

28. The system of claim 25, wherein the transaction request message is a short code that includes information relating to said transaction.

29. The system of claim 28, wherein said application means further extracting said information relating to said transaction includes information associated to said mobile device and a product code.

30. The system of claim 27, wherein said storage means storing in said user profile information relating to a shipping address of said user and said participant validation message includes said shipping address of said user.

31. The system of claim 29, wherein said storage means storing in said participant profile information relating to a product, charity, or service and associating said information to a product code, such that when said application means receives said transaction request message that includes said product code, said application means linking said transaction to said product, charity or service.

32. A system for conducting a transfer of funds between two users, each user having a mobile device, the system comprising:
a storage means storing a plurality of user profiles, each user profile corresponding to a user and including information associated to a mobile device and a user bank account;
an application means, which when a request message from a first mobile device associated to a first user is received, and said request message relating to a transfer of funds from said first user to a second user, said application means generating an authorization message in response to said request message and further sending said authorization message to said first mobile device,
wherein when an acknowledgement message is received from said first mobile device authorizing said transfer, said application means generating a validation message and further sending said validation message to said first mobile device and a second mobile device associated to said second user, and
said application means further initiating an electronic transfer of funds from said first user bank account to said second user bank account.

33. The system of claim 32, wherein said application means extracts from said request message information relating to said second mobile device.

34. A system for conducting a transfer of funds between two users, each user having a mobile device, the system comprising:
a storage means storing a plurality of user profiles, each user profile corresponding to a user and including information associated to a mobile device and a user bank account;
an application means, which when a request message from a first mobile device associated to a first user is received, and said request message relating to a transfer of funds from a second user to said first user, said application means extracting from said request message information relating to a second mobile device associated to said second user, and said application means further generating an authorization message in response to said request message and further sending said authorization message to said second mobile device,
wherein when an acknowledgement message is received from said second mobile device authorizing said transfer, said application means generating a validation message and further sending said validation message to said first mobile device and to said second mobile device, and
said application means further initiating an electronic transfer of funds from said first user bank account to said second user bank account.

35. A system for authenticating a user of a mobile device, the system comprising:
a storage means storing a user profile corresponding to said user and including information associated to a mobile device and associated with said user;
an application means, which when a message is received from a device requesting authentication of said user, said application means generating an authorization message in response to said authentication request message and further sending said authorization message to said mobile device,
wherein when an acknowledgment response is received from said mobile device, said application means further authenticating said user of said mobile device and further generating a validation message and further sending said validation message to said device authenticating said user of said mobile device.

36. The system of claim 35, wherein said application means further extracting an user authorization code placed in said acknowledgment response and further comparing said authorization code to a predefined authorization code stored in said user profile.

37. The system of claim 36, wherein said authorization code is a four digit code.

38. The system of claim 35, wherein said validation message includes an age associated to said user.

39. The system of claim 35, wherein said validation message includes a picture image associated to said user.
